(19) United States
(12) Patent Application Publication
(10) Pub. No.: US 2006/0017966 A1
(43) Pub. Date: Jan. 26, 2006

(54) System and method for multiple users to access one or more data services

(75) Inventor: Louis Ormond, Irvine, CA (US)

Correspondence Address: TUCKER, ELLIS & WEST LLP, 1150 HUNTINGTON BUILDING, 925 EUCLID AVENUE, CLEVELAND, OH, 44115-1475, US

(73) Assignees: Toshiba Corporation; Toshiba Tec Kabushiki Kaisha

(21) Appl. No.: 11/184,359

(22) Filed: Jul. 19, 2005

Related U.S. Application Data
(60) Provisional application No. 60/589,471, filed on Jul. 20, 2004.

(51) Int. Cl. G06F 15/00

(52) U.S. Cl. 358/1.15

(57) ABSTRACT

A system and method for remotely accessing a plurality of document processing operations. A mobile user is provided remote access to a multifunctional peripheral device. The user is provided information about the various services available, such as scanning, printing, distribution, optical character recognition, and the available payment options. The user selects the appropriate payment method and inputs job parameters regarding performance of the selection operation. The user is then presented with the total cost of the service. Upon the user accepting the total cost of the service, the service is performed and the user is billed for the service. In addition, multiple users have the ability to access the multifunctional peripheral devices for services from the same interface.

### CROSS-REFERENCE TO RELATED APPLICATION

This Application claims the benefit of U.S. Provisional Application Ser. No. 60/589,471 filed Jul. 20, 2004, entitled, “SYSTEM AND METHOD FOR MULTIPLE USERS TO ACCESS ONE OR MORE DATA SERVICES”, which is incorporated by reference herein.

### BACKGROUND

This invention is directed to a system and method for accessing data services by mobile users. More particularly, this invention is directed to a user interface which allows users in a non-office environment to access and use data services from multiple multifunction peripheral devices, such as scanning, printing, and distribution of documents and data. In addition, this invention is directed to a user interface which allows multiple users to access and use data services from one or more multifunctional peripheral devices.

Typically, users routinely work with documents or other data while away from their office environment. These users need to generate image data, by printing or scanning a document, and then to need to distribute or perform other functions on such image data. Multifunctional peripheral devices, such as printers and scanning devices, routinely perform such operations. The user accesses the data services via a user interface. The user interface is associated with or connected to the multifunctional peripheral device, such as a kiosk remote panel system. Currently there is one user interface or kiosk associated with each multifunctional peripheral device and that user interface or kiosk only functions in connection with that one multifunctional peripheral device. If there are multiple multifunctional peripheral devices at a location, multiple user interfaces or kiosks are needed for each device. The user interface or kiosk may be relatively expensive, such that the cost is to purchase the user interface or kiosk becomes a burden to the system return on investment

There is a need for a system and method for accessing data services by mobile users wherein more than one multifunctional peripheral device is able to be accessed by an associated user interface or kiosk. There is also a need for a system and method for accessing data services by mobile user wherein one than user is able to access one or more multifunctional peripheral devices from a user interface or kiosk.

### SUMMARY OF INVENTION

In accordance with the present invention, there is provided a system and method for accessing data services by mobile users.

Further, in accordance with the present invention, there is provided a user interface which allows users in non-office environments to access and use data services provided by multiple multifunction peripheral devices, such as scanning, printing, and distribution of documents and data.

Further, in accordance with the present invention, there is provided a user interface which allows a user to access or operate data services from multiple multifunctional peripheral devices.

Further, in accordance with the present invention, there is provided a user interface which allows multiple users to access or operate data services for one or more multifunctional peripheral devices.

In the present invention, a mobile user is provided access to a multifunctional peripheral device in a non-office environment, such an airport lounge or hotel business center. The user is provided information about the various services available, such as scanning, printing, distribution, optical character recognition, and the available payment options. The user then selects the appropriate payment option. The user then provides selected information about the service the user wants to be performed. The user is then presented with the total cost of the service. Upon the user accepting the charges, the service is performed. The details of the transaction are archived and the user is billed for the service. The user also has the ability to access additional multifunctional peripheral devices for services from the same user interface. If the user desires to perform additional services on an additional device, the user repeats the same process for the additional services. In addition, multiple users have the ability to access the multifunctional peripheral devices for services from the same interface.

In accordance with the present invention, there is provided a system for remotely accessing a plurality of document processing operations. The system includes communications means adapted to communicate, to an associated remote user interface, data representing multiple available document processing operations. The system also includes receiving means adapted to receive, via the remote user interface, selection data representing at least one of the document processing operations to be performed on at least one selected electronic document. The system further includes calculation means adapted to calculate the cost for performing the document processing according to the received selection data. The communication means further includes receiving means adapted to receive, via the remote user interface, order data confirming the acceptance of the cost for performing document processing. The system also employs commencement means adapted to commence the document processing according to the selection data.

Further in accordance with the present invention, there is provided a method for remotely accessing a plurality of document processing operations. The method begins by communicating data representing a plurality of available document processing operations to an associated user interface. Via the remote user interface, selection data is received representing at least one of the document processing operations to be performed on at least one selected electronic document. Cost data is then calculated representing the cost associated with performing the document processing according to the received selection data. Via the remote user interface, order data is received confirming acceptance of the cost data for performing the document processing according to the selection data. The document processing then commences in accordance with the selection data.

Still other aspects of the present invention will become readily apparent to those skilled in this art from the following description wherein there is shown and described a preferred embodiment of this invention, simply by way of illustration of one of the best modes suited for to carry out the invention. As it will be realized, the invention is capable of other different embodiments and its several details are capable of modifications in various obvious aspects all without departing from the invention. Accordingly, the drawing and descriptions will be regarded as illustrative in nature and not as restrictive.

### BRIEF DESCRIPTION OF THE DRAWINGS

The accompanying drawings incorporated in and forming a part of the specification, illustrate several aspects of the present invention, and together with the description serve to explain the principles of the invention. In the drawings:

FIG. 1 is a block diagram illustrating a system for accessing fee-based data services by mobile users in accordance with the present invention; and

FIG. 2 is a flow chart illustrating a method for accessing fee-based services by mobile users in accordance with the present invention;

FIG. 3 is a flow chart illustrating a method for accessing fee-based services by mobile users in accordance with the present invention;

FIG. 4 is a flow chart illustrating a method for accessing fee-based services by mobile users in accordance with the present invention;

FIG. 5 is a screen template illustrating a user interface in accordance with the present invention;

FIG. 6 is a screen template illustrating a user interface in accordance with the present invention; and

FIG. 7 is a screen template illustrating a user interface in accordance with the present invention.

### DETAILED DESCRIPTION OF THE PREFERRED EMBODIMENT

The present invention is directed to a system and method for providing fee-based data services to mobile users. More particularly, the present invention is directed to a system and method for remotely accessing a plurality of document processing operations.

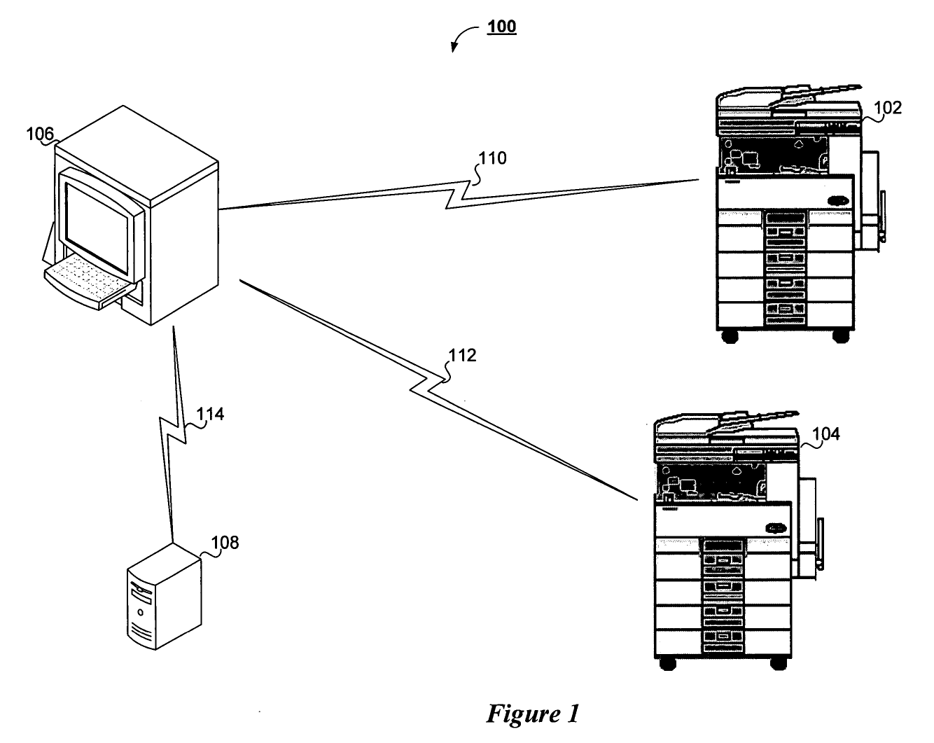

Turning now to FIG. 1, there is illustrated a block diagram of a system 100 is shown in FIG. 1. In the present invention, a mobile user is provided access to one or more multifunctional peripheral devices, shown in FIG. 1 as the multifunctional peripheral devices 102 and 104. As illustrated in FIG. 1, the multifunctional peripheral devices 102 and 104 are suitably located in a non-office environment, such as an airport lounge, retail location, or business center. Other non-office environment locations include, but are not limited to, university campuses, conference centers, libraries, and hotels. The user accesses the multifunctional peripheral devices 102 and 104 directly or via a computer or kiosk 106 using a suitable communications links 110 and 112, respectively. It will be appreciated by those skilled in the art that the multifunctional peripheral devices are any suitable multifunctional peripheral device known in the art, such as a copier, printer, scanner, facsimile and the like, or any combination thereof. Suitable commercially available multifunctional peripheral devices include, but are not limited to, the Toshiba e-Studio Series Controller. It will further be understood by those skilled in the art that while the present description employs two multifunctional peripheral devices 102 and 104, the present invention is not limited thereto. For example and without limitation, the present invention is equally capable of using a single multifunctional peripheral device or more than two multifunctional peripheral devices, without departing from the scope of the subject invention.

A user interface is presented on the device or computer allowing the user to access the devices and associated services. In the preferred embodiment, the user interface is a touch screen display, capable of both displaying data to a user, as well as receiving user input. It will be understood by those skilled in the art that any suitable user interface known in the art, including, but not limited to an alphanumeric keypad, an LCD, and the like, are equally capable of being employed by the present invention. In another embodiment, the user accesses the multifunctional peripheral device via a wireless device and connect using at least one of Bluetooth® standard, 802.11 g (WiFi) and other 802.11 compliant devices. In another embodiment, the user interface allows multiple users to access the one or more multifunctional peripheral devices from the single user interface. As will be understood by those skilled in the art, the communications links 110, 112 are any means for communication between electronic devices, including for example and without limitation, an Ethernet based network, infrared connection, Wi-Fi connection or other 802.11(x)-based wireless connection, telephone connection, cellular connection, Bluetooth® standard-based connection and the like or any combination of communication means thereof.

The multifunctional peripheral devices 102, 104 are communicatively coupled to an associated central server 108 via a suitable communications link, such as the Internet. As shown in FIG. 1, the multifunctional peripheral devices 102, 104 suitably employ the kiosk 106 to facilitate data communication with the central server 108, however the present invention is equally adaptable to using direct communication between the devices 102 and 104, without using the kiosk 106, such that the associated user interface of device 102 is suitably capable of controlling document processing operations of the second multifunctional peripheral device 104, and communicate with the central server 108. Preferably, the central server 108 and the kiosk 106 suitably communicate via the communications link 114. As will be understood by those skilled in the art, the communications link 114 is any means for communication between electronic devices, including for example and without limitation, a telephone connection, a cellular connection, an infrared connection, a Wi-Fi connection or other 802.11(x)-based wireless connection, an Ethernet based network, a Bluetooth® standard-based connection and the like or any combination of communication means thereof.

The user is then provided with information about the services available to be performed. The information is provided in any suitable manner known in the art. The information is suitably provided by way of a user interface associated with the multifunctional peripheral device or documentation provided related thereto. In the preferred embodiment, the kiosk 106 suitably displays, via any means known in the art, the services to the user using an associated user interface device. The services provided to the user are those typically provided by multifunctional peripheral devices and associated software. In one embodiment, the system allows the user to generate or receive image data using the multifunctional peripheral device and then stores or archives such image data in an associated repository.

In another embodiment, the system allows the user to generate or receive image data using the multifunctional peripheral device, perform optical character recognition on the image data, and then transmit the image data to at least one selected destination. In a further embodiment, the system allows the user to generate or receive image data and then distribute the image data to at least one selected destination. In yet another embodiment, the system allows the user to generate or receive image data and then to output the image data according to the parameters selected by the user.

In a preferred embodiment, the user is then provided with information about the available payment options for paying for the desired services. The user then selects the desired payment option from the options provided. After selecting the desired payment option, the user is prompted to provide selected information about the desired service to be performed. Once the user has accepted the services by any suitable means known in the art, the services are performed. The user is then billed for the services performed depending on the payment option selected by any suitable means known in the art.

As shown in FIG. 1, the system 100 employs the kiosk 106 to facilitate selection of one or both of the multifunctional peripheral devices 102, 104 by one or more users. In operation, the present invention enables one or more users to select document processing operations using the kiosk 106, via a split-screen user interface, which is further described below. The users are able to select the same device, both devices, or devices remotely located from the kiosk 106. It will be understood by those skilled in the art that the present invention enables a single user to select multiple multifunctional peripheral devices 102, 104 to process a single document processing operation, or multiple document processing operations.

In addition, the skilled artisan will appreciate that the present invention allows multiple users to select and make use of the same or multiple multifunctional peripheral devices 102, 104 to contemporaneously process selected document processing operations. For example, and without limitation, a first user is able to select the multifunctional peripheral device 102 to output a print job. During the output of the print job, the user is able to select, via the kiosk 106, the second multifunctional peripheral device 104 to transmit a facsimile of a document. Alternatively, a second user, accessing the second multifunctional peripheral device 104 via a split-screen user interface associated with the kiosk 106, suitably scans a document to storage on the central server 108. Those skilled in the art will better appreciate the foregoing system in connection with the additional figures, discussed below.

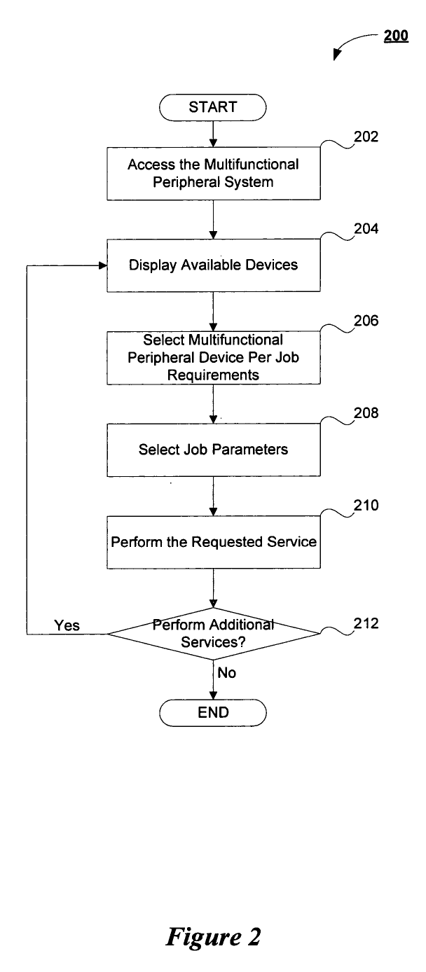

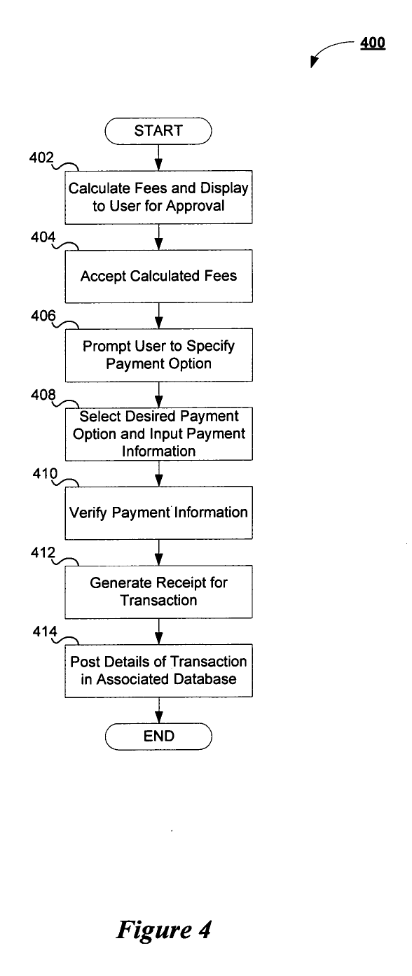

Turning now to FIG. 2, there is shown a flowchart 200 illustrating a method for accessing data services in accordance with the present invention. Beginning at step 202, the user access the multifunctional peripheral system via the user interface associated with the multifunctional peripheral devices 102, 104, the kiosk 106, or via any suitable means as described above. The user interface shows the available multifunctional peripheral devices as shown at 204. At 206, the user selects the multifunctional peripheral device to perform the services based on the job requirements. For example, the user is able to select more than one multifunctional peripheral device to process a large print job, wherein the available selected devices share the processing of the large print job. The present invention also enables the user to select one device to process a large print job, while employing a second device to perform several other smaller document processing operations. At 208, the user selects the parameters or properties for the job. Once the desired parameters have been selected, flow proceeds to step 210, wherein the selected multifunctional peripheral device performs the desired document processing operation. In one embodiment, the system further charges the user for the costs associated with the selected document processing operations, as set forth below in FIG. 4.

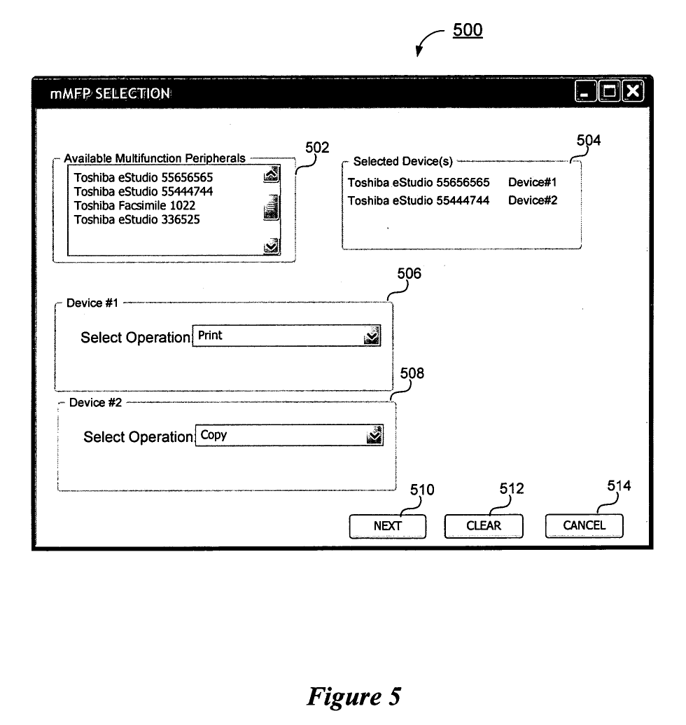

At 212, a determination is made whether the user desires to perform additional services on the selected multifunctional peripheral device or other multifunctional peripheral devices. If the user does not desire additional services, the process terminates. If the user desires additional services, the process returns to 204 wherein the user selects the desired device and services. While shown at the end of the processing of the first job, it is understood by one of skill in the art, that the user is able to select additional services at any time during the processing of the first job. The foregoing method will better be understood in connection with the template screen of FIG. 5, illustrating one embodiment of a user interface for selecting a multifunctional peripheral device in accordance with the present invention.

Turning now to FIG. 5 there is shown a screen template 500 illustrating a graphical user interface for the accessing of a multifunctional peripheral device by a mobile user in accordance with the present invention. The skilled artisan will appreciate that the template 500 depicted in FIG. 5 is for example purposes only and the present invention is not limited to the format disclosed thereon. As shown in FIG. 5, the template 500 suitably comprises a graphical user interface, suitably displayed on the kiosk 106, or alternatively on the associated displays of the one or more multifunctional peripheral devices 102 and 104. The template screen 500 includes a display of the available multifunctional peripheral devices, shown as the selection box 502. The selection box 502 includes a listing of those document processing devices available to the user on the system 100. As will be understood by those skilled in the art, the user advantageously employs any methods known in the art to select one or more devices, including, without limitation, depressing the control key while selecting more than one item in the list.

Selected document processing devices are suitably displayed in the selected devices box 504. As show n in FIG. 5, each of the selected devices are assigned a device number. Those skilled in the art will appreciate that the assignment of a device number is suitably displayed herein for example purposes only and the present invention is not so limited to the template 500 of FIG. 5. Upon the selection of a device, the user is prompted to select a desired document processing operation, using the graphical icons illustrated in FIG. 5. For example, upon the user selection of device 1, as shown in box 504, a pull-down menu of available document processing operations is suitably displayed in the device 1 box 506. The user is capable of selecting the one or more desired document processing operations from this listing. In the event that the user has selected more than one device, a second box 508, corresponding to device 2, shown in box 504, is advantageously displayed, enabling the user to select the one or more desired document processing operations to be performed by the second document processing device. It will be appreciated by those skilled in the art that the template 500 suitably displays two devices, in accordance with the example system 100 of FIG. 1. It will be understood by the skilled artisan that the present invention is equally capable of implementing a single device or more than two devices, with the template 500 reflecting the number of devices selected.

Once the user has selected the desired devices and the desired document processing operations, the user selects the next icon 510 to proceed with the document processing operations selected. When the user desires to clear the template 500 of the selected information, the user selects the clear icon 512, wherein the screen returns to an unselected state and the user is able to begin the selection process again. When the user desires to end the session, or exit the system, the user selects the cancel icon 514, wherein the process terminates and the system is ready for the next user.

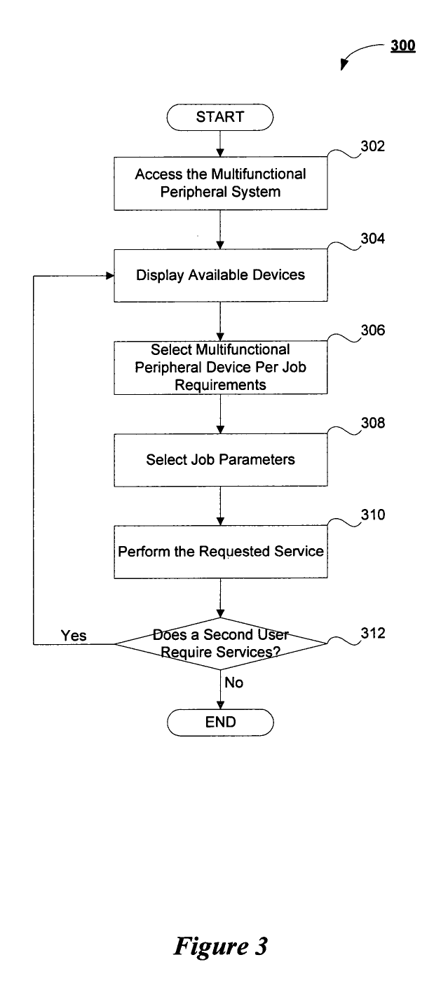

Referring now to FIG. 3, there is shown a flowchart for allowing multiple users to access data services according to the present invention. A user access the multifunctional peripheral system via the user interface via any suitable means as described above as shown at 302. The user interface shows the available multifunctional peripheral devices as shown at 304. At 306, the user selects the multifunctional peripheral device to perform the services based on the job requirements. At 308, the user selects the parameters or properties for the job. Once the desired parameters have been input, the selected multifunctional peripheral device performs the document processing operation at step 310. In one embodiment, the user is charged for the costs associated with the selected document processing operations, as set forth below in FIG. 4.

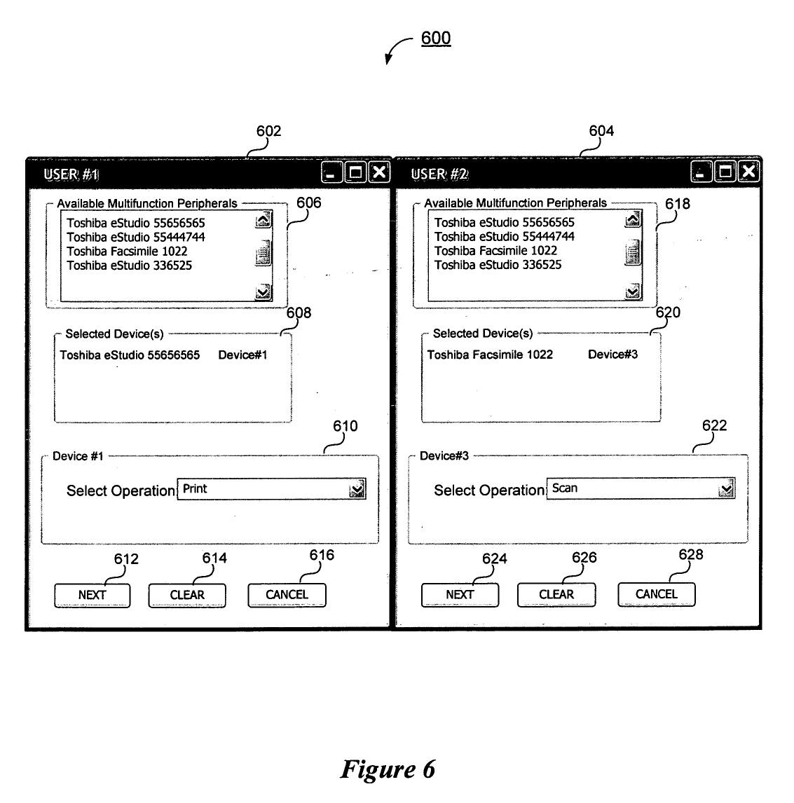

At 312, a determination is made whether a second user desires to perform additional services on the selected multifunctional peripheral device or other multifunctional peripheral devices. If no second user desires to access the services, the process terminates. If a second user does desire to access the services, the process returns to 304 wherein the second user selects the desired device and services. While shown at the end of the processing of the first job, it is understood by one of skill in the art, that the second user is able to access the services at any time during the processing of the first job. As previously mentioned, the present invention is capable of enabling simultaneous access to the multifunctional peripheral devices 102 and 104 to a single or multiple users. FIG. 6 illustrates a screen template 600 showing one embodiment wherein two users are able to simultaneously access the system in accordance with the present invention.

As shown in FIG. 6, the template suitably includes two windows, or panes 602 and 604, corresponding to two users. The left-pane 602 corresponds to the first user, while the right-pane 604 corresponds to the second user. In accordance with the present invention, the users are able to access the same multifunctional peripheral devices, or alternatively, to select different devices, for document processing operations. In the preferred embodiment, the touch-screen associated with the kiosk 106 advantageously is divided into the panes 602 and 604. Those skilled in the art will appreciate the cost savings and benefits to using the same touch-screen for multiple users. It will be understood, however, that the present invention is equally capable of using more than one touch-screen or kiosk to facilitate multiple users and the present invention is not limited solely to the shared screen of FIG. 6.

As previously set forth above with respect to FIG. 5, each pane 602, 604 of FIG. 6 provides the users with the ability to select one or more document processing devices from the selection boxes 606 and 618, respectively. The first user suitably uses the left-pane 602 to select one of the available multifunction peripherals from the list shown in box 606. The first user's selection is advantageously displayed in the selected device box 608. As shown in FIG. 6, the selected device is assigned a device number. Those skilled in the art will appreciate that the assignment of a device number is suitably displayed herein for example purposes only. Upon the selection of a device, the first user is prompted to select a desired document processing operation, using the graphical icons illustrated in FIG. 6. For example, upon the user selection of device 1, as shown in box 608, a pull-down menu of available document processing operations is suitably displayed in the device 1 box 610. The first user is capable of selecting the one or more desired document processing operations from this listing. It will be understood by the skilled artisan that the present invention is equally capable of implementing a single device or more than two devices, with the template 600 reflecting the number of devices selected.

Once the first user has selected the desired devices and the desired document processing operations, the user selects the next icon 612 to proceed with the document processing operations selected. When the first user desires to clear the selected information, the first user selects the clear icon 614, wherein the screen returns to an unselected state and the first user is able to begin the selection process again. When the first user desires to end the session, or exit the system, the first user selects the cancel icon 616, wherein the process terminates and the system is ready for the next user.

Contemporaneously with the first user, the second user is able to select one of the available multifunction peripherals from the list shown in box 618. The second user's selection is then displayed in the selected device box 620. As previously discussed, the selected device is assigned a device number. Following device selection, the second user selects a desired document processing operation, using the icons shown in FIG. 6. Thus, for example, after the second user's selection of device 3, as shown in box 620, a pull-down menu of available document processing operations is suitably displayed in the device 3 box 622. The second user then selects one or more desired document processing operations from this listing. It will be understood by the skilled artisan that the present invention is capable of implementing a single device or more than two devices, with the template 600 reflecting the number of devices selected.

Once the second user has selected the desired device and the desired document processing operations, the second user selects the next icon 624 to proceed with the document processing operations selected. When the second user desires to clear the selected information, the second user selects the clear icon 626, wherein the screen returns to an unselected state and the second user is able to begin the selection process again. When the second user desires to end the session, or exit the system, the second user selects the cancel icon 628, wherein the process terminates and the system is ready for the next user.

Referring now to FIG. 4, there is shown a flow chart 400 illustrating the cost recovery operation performed in accordance with the present invention. FIG. 4 shows a flowchart for providing fee-based data services to users in a non-office environment according to the present invention. Following access of the multifunctional peripheral system, as explained above with respect to FIGS. 2 and 3, the user is presented with a description of the document processing services capable of being performed by the selected multifunctional peripheral devices and the available payment options. Beginning at step 402, the system calculates the appropriate charges via any suitable means and presents the charges to the user via any suitable means for user approval. At 404, the user accepts the transaction via any suitable means. At 406, the user is prompted to specify a payment option via any suitable means and to provide the necessary information for the associated payment option.

At 408, the user selects the desired payment option via any suitable means and provides the information required to effectuate such payment via any suitable means. At step 410, the system verifies the payment information received from the user. Upon verification of the payment information, a receipt for the transaction is generated at step 412 by the multifunctional peripheral device. The details of the transaction are posted in an associated database via any suitable means for later retrieval as shown at 414.

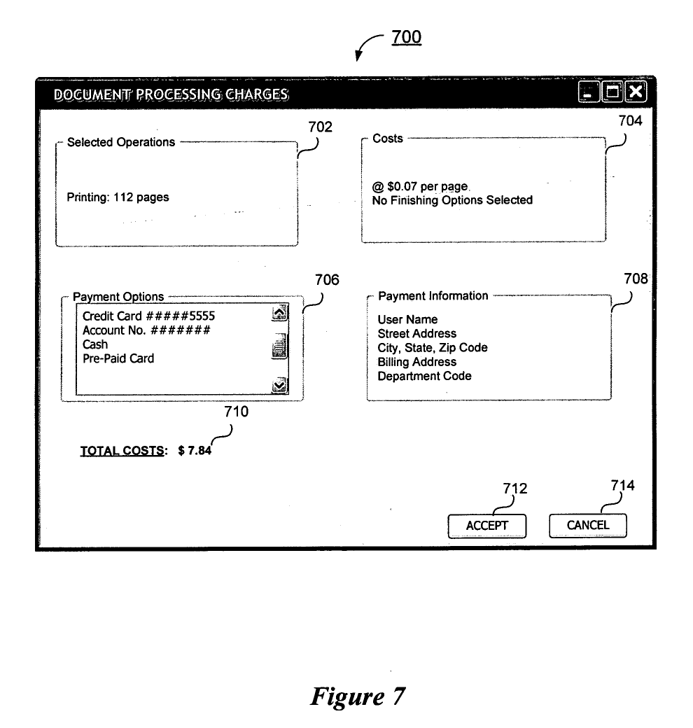

Turning now to FIG. 7 there is shown a screen template 700 illustrating a graphical user interface for the acceptance of costs associated with the performance of document processing operations by a selected multifunctional peripheral device in accordance with the present invention. The skilled artisan will appreciate that the template 700 depicted in FIG. 7 is for example purposes only and the present invention is not limited to the format disclosed thereon. As shown in FIG. 7, the template 700 suitably displays the selected document processing operations at box 702. For ease of explanation, only a single document processing operation is shown in FIG. 7, however, those skilled in the art will understand that the present invention is equally capable of displaying more than one document processing operation in the box 702 corresponding to document processing operations selected by the user.

The template 700 further includes a display box 704 illustrating the costs associated with the performance of the document processing operation. For example and without limitation, the box 704 depicts a per-page cost for each page printed by the selected document processing device. As will be understood by those skilled in the art, the charges assessed in accordance with the present invention are capable of being implemented as flat-fee, pre-paid debiting, reduced cost, and the like, in addition to the per-page basis illustrated in FIG. 7. Furthermore, the skilled artisan will understand that the selection of finishing options, now shown, will further affect the costs associated with the performance of the document processing operation.

The user is prompted to select a payment option from the option box 706. As will be understood by those skilled in the art, the user is suitably required to input a credit card number, when using the credit card payment option, a valid customer/client account number, when using the account payment option, a valid pre-paid authorization card/code, when using the pre-paid payment option, and the like. When using any payment method other than the cash option, the user is suitably prompted to input, if required, contact information corresponding to the payment method selected in box 708. The total costs associated with the document processing operations are then displayed at 710. It will be understood by those skilled in the art that the total costs are capable of adjustment based upon coupon usage, quantity discounts, customer preferences, and the like. The user then accepts the costs associated with the selected document processing operations by selecting the accept icon 712, or cancels the selected document processing operations by selecting the cancel icon 714. It will be appreciated by those skilled in the art that following acceptance of the costs by the user, the selected document processing operations are performed by the selected multifunctional peripheral device(s) in accordance with the methods discussed above.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed is:

1. A system for remotely accessing a plurality of document processing operations comprising:
communication means including means adapted for communicating, to an associated remote user interface, data representative of a plurality of available document processing operations;
means adapted for receiving, via the associated remote user interface, selection data representative of at least one of the document processing operations to be performed on at least one selected electronic document;
calculation means adapted for calculating cost data representative of a cost for performing document processing in accordance with received selection data;
the communication means including means adapted for receiving, via the associated remote user interface, order data confirming acceptance of the cost data for performing document processing in accordance with the selection data; and
means adapted for commencing the document processing in accordance with the selection data.

2. The system for remotely accessing a plurality of document processing operations of claim 1 wherein the available document processing operations are chosen from a set of functions comprising printing, copying, faxing, e-mailing, translating, formatting, combining, and storing of the at least one selected electronic document.

3. The system for remotely accessing a plurality of document processing operations of claim 2, wherein the communication means includes means adapted for communicating via an associated network.

4. The system for remotely accessing a plurality of document processing operations of claim 3 wherein the associated network includes a network from the set comprising cellular, LAN, WLAN, Internet, point-to-point wired and point-to-point wireless data communication.

5. The system for remotely accessing a plurality of document processing operations of claim 2 wherein:
the communicating means further includes,
means adapted for communicating, via the associated remote user interface, data representative of a plurality of optional devices available to complete a function;
means adapted for receiving, via the associated remote user interface, device selection data representative of a selected optional device; and
the means adapted for commencing the document processing includes means for commencing the document processing on the selected optional device.

6. A method for remotely accessing a plurality of document processing operations comprising the steps of:
communicating, to an associated remote user interface, data representative of a plurality of available document processing operations;
receiving, via the associated remote user interface, selection data representative of at least one of the document processing operations to be performed on at least one selected electronic document;
calculating cost data representative of a cost for performing document processing in accordance with received selection data;
receiving, via the associated remote user interface, order data confirming acceptance of the cost data for performing document processing in accordance with the selection data; and
commencing the document processing in accordance with the selection data.

7. The method for remotely accessing a plurality of document processing operations of claim 6, wherein the available document processing operations are chosen from a set of functions comprising printing, copying, faxing, e-mailing, translating, formatting, combining, and storing of the at least one selected electronic document.

8. The method for remotely accessing a plurality of document processing operations of claim 7, further comprising the step of communicating via an associated network.

9. The method for remotely accessing a plurality of document processing operations of claim 8, wherein the associated network includes a network from the set comprising cellular, LAN, WLAN, Internet, point-to-point wired and point-to-point wireless data communication.

10. The method for remotely accessing a plurality of document processing operations of claim 7 further comprising the steps of:
communicating, via the associated remote user interface, data representative of a plurality of optional devices available to complete a function;
receiving, via the associated remote user interface, device selection data representative of a selected optional device; and
commencing the document processing on the selected optional device.

11. A computer-readable medium of instructions with computer-readable instructions stored thereon for remotely accessing a plurality of document processing operations comprising:
instructions for communicating, to an associated remote user interface, data representative of a plurality of available document processing operations;
instructions for receiving, via the associated remote user interface, selection data representative of at least one of the document processing operations to be performed on at least one selected electronic document;
instructions for calculating cost data representative of a cost for performing document processing in accordance with received selection data;
instructions for receiving, via the associated remote user interface, order data confirming acceptance of the cost data for performing document processing in accordance with the selection data; and
instructions for commencing the document processing in accordance with the selection data.

12. The computer-readable medium of instructions with computer-readable instructions stored thereon for remotely accessing a plurality of document processing operations of claim 11, wherein the available document processing operations are chosen from a set of functions comprising printing, copying, faxing, e-mailing, translating, formatting, combining, and storing of the at least one selected electronic document.

13. The computer-readable medium of instructions with computer-readable instructions stored thereon for remotely accessing a plurality of document processing operations of claim 12, further comprising instructions for communicating via an associated network.

14. The computer-readable medium of instructions with computer-readable instructions stored thereon for remotely accessing a plurality of document processing operations of claim 13, wherein the associated network includes a network from the set comprising cellular, LAN, WLAN, Internet, point-to-point wired and point-to-point wireless data communication.

15. The computer-readable medium of instructions with computer-readable instructions stored thereon for remotely accessing a plurality of document processing operations of claim 12 further comprising:
instructions for communicating, via the associated remote user interface, data representative of a plurality of optional devices available to complete a function;
instructions for receiving, via the associated remote user interface, device selection data representative of a selected optional device; and
instructions for commencing the document processing on the selected optional device.

16. A computer-implemented method for remotely accessing a plurality of document processing operations comprising the steps of:
communicating, to an associated remote user interface, data representative of a plurality of available document processing operations;
receiving, via the associated remote user interface, selection data representative of at least one of the document processing operations to be performed on at least one selected electronic document;
calculating cost data representative of a cost for performing document processing in accordance with received selection data;
receiving, via the associated remote user interface, order data confirming acceptance of the cost data for performing document processing in accordance with the selection data; and
commencing the document processing in accordance with the selection data.

17. The computer-implemented method for remotely accessing a plurality of document processing operations of claim 16, wherein the available document processing operations are chosen from a set of functions comprising printing, copying, faxing, e-mailing, translating, formatting, combining, and storing of the at least one selected electronic document.

18. The computer-implemented method for remotely accessing a plurality of document processing operations of claim 17, further comprising the step of communicating via an associated network.

19. The computer-implemented method for remotely accessing a plurality of document processing operations of claim 18, wherein the associated network includes a network from the set comprising cellular, LAN, WLAN, Internet, point-to-point wired and point-to-point wireless data communication.

20. The computer-implemented method for remotely accessing a plurality of document processing operations of claim 17 further comprising the steps of:
communicating, via the associated remote user interface, data representative of a plurality of optional devices available to complete a function;
receiving, via the associated remote user interface, device selection data representative of a selected optional device; and
commencing the document processing on the selected optional device.
